(19) United States
(12) Patent Application Publication
(10) Pub. No.: US 2017/0113592 A1
(43) Pub. Date: Apr. 27, 2017

(54) Bin Carrier System

(71) Applicant: John Jene Dagorret, Tampa, FL (US)

(72) Inventor: John Jene Dagorret, Tampa, FL (US)

(21) Appl. No.: 14/922,856

(22) Filed: Oct. 26, 2015

(51) Int. Cl. B60P 1/43; B60P 1/36; B60P 1/02

(52) U.S. Cl. CPC B60P 1/43; B60P 1/02; B60P 1/36

(57) ABSTRACT

A bin carrier system that includes a tractor having a maximum width that permits the tractor to navigate between narrow rows of fruit trees and other produce crops such as, for example, dwarf varieties of apple trees. The tractor includes a storage compartment into which multiple produce bins can be collected for transport out of an orchard or field. The tractor can also include an elevated platform on which one or more individuals can stand while the tractor is stationary or mobile. The system can also feature a sensor to detect proximity or contact with a plant. The system can also feature an automatic steering system to guide the tractor between rows of plants.

### CROSS-REFERENCE TO RELATED APPLICATIONS

This application is a continuation application of and claims priority from U.S. nonprovisional patent application Ser. No. 12/791,851 filed Jun. 1, 2010, and U.S. provisional patent application Ser. No. 61/182,146 filed May 29, 2009. The foregoing applications are incorporated in its entirety herein by this reference.

### FIELD OF THE INVENTION

The invention relates to methods and systems for transporting containers. More particularly, the invention relates to methods and systems for collecting and transporting fruit and vegetable bins.

### BACKGROUND

Conventional produce-collecting machines are standard-sized tractors and trailers drawn behind those tractors. Standard-sized tractors and trailers can navigate standard-sized field cultivation and orchard rows with ease, however, they may be unable to navigate between narrow rows used for dwarf varieties of fruit trees or for high-density row planting. Many crop plants may be planted in rows with less space between each row to increase the density of plants, thereby yielding a larger amount of produce from each crop. The same holds true for dwarf variety apples and other dwarf fruit trees, which may be planted in closely spaced rows to maximize the size of the harvest. Conventional tractors and trailers are too wide to navigate these closely spaced plant rows. The widely spaced rows required to accommodate conventional farming equipment results in a loss of efficiency from the perspective of space usage and plant density as well as reduced harvest size.

A need exists for a narrow bin carrier machine so that crops picked in fields and orchards having closely spaced rows may be quickly and efficiently transported out of the field or orchard by mechanical means.

### SUMMARY

The machine and methods described herein can utilize a tractor having a frame and maximum width that are more narrow than those of standard-sized tractors. The tractor can include a storage compartment that features an air cushion ride installed on a frame of the tractor. The tractor can also feature an operator compartment containing steering and other controls for the tractor. The operator compartment can be collinearly aligned with and behind the storage compartment or the operator compartment may be elevated above the storage compartment. The storage compartment can include a front portion that is vertically adjustable and a rear portion that can be fixed in a horizontal position. The front portion of the storage compartment can include at least two prongs that can be lowered and raised to lift bins containing produce into the storage compartment. The prongs and other portions of the storage compartment can include chain rollers that may be mechanically controlled and operated. The chain rollers may be connected to a motor that is reversible so that the direction of movement of the chain rollers can be controlled by a user. The chain rollers may circulate in a direction toward the rear portion of the storage compartment when bins are being loaded into the storage compartment. When bins are being unloaded from the storage compartment, the direction of movement of the chain rollers can be reversed so as to circulate toward the front portion of the storage compartment.

The bin carrier machine can be manufactured with a maximum width that enables the tractor to navigate narrow rows or fruit trees, e.g., dwarf apple or dwarf citrus trees, or other narrowly spaced rows of produce such as vegetables between which conventional tractors are unable to move.

Accordingly, the invention features a bin carrier machine that can include a tractor, which has a storage compartment into which a plurality of bins can be loaded. The maximum width of the tractor can enable the tractor to navigate between closely spaced rows of plants.

In another aspect, the invention can feature the storage compartment including a front portion that is vertically adjustable and a rear portion.

In another aspect, the invention can feature the front portion of the storage compartment being vertically adjustable in height from a lowered position to a raised position.

In another aspect, the invention can feature the front portion of the storage compartment being vertically adjustable via hydraulic means.

In another aspect, the invention can feature the front portion of the storage compartment including at least two prongs.

In another aspect, the invention can feature the storage compartment including at least two front chain rollers installed on a floor of the storage compartment.

In another aspect, the invention can feature the front chain rollers being mechanically reversible in direction.

In another aspect, the invention can feature the rear portion of the storage compartment being fixed in a horizontal position.

In another aspect, the invention can feature the bin carrier machine including at least one elevated platform.

In another aspect, the invention can feature the bin carrier machine including at least one sensor.

In another aspect, the invention can feature the plants being fruit trees.

In another aspect, the invention can feature the fruit trees being of a dwarf variety.

In another aspect, the invention can feature the bin carrier machine including a plurality of tires and an operator compartment.

In another aspect, the invention can feature the operator compartment being aligned collinearly behind the storage compartment.

In another aspect, the invention can feature the operator compartment being elevated above the storage compartment.

In another aspect, the invention can feature the operator compartment being positioned offset to one side of the storage compartment.

In another aspect, the invention can feature the bin carrier machine further including a camera to facilitate loading of bins.

In another aspect, the invention can feature the bin carrier machine further including a frame comprising an air cushion.

In another aspect, the invention can feature the bin carrier machine further including a hydraulic suspension system.

The invention also features a method for planting and harvesting crops. The method can comprise the steps of: (a) planting produce crops in a first location in rows spaced about 10 feet apart or less; (b) picking produce and placing the produce into a plurality of bins; (c) navigating a bin carrier machine with a maximum width of about 72 inches between the rows; (d) collecting the plurality of bins by placing the plurality of bins into a storage area of the bin carrier machine; and (e) transporting the produce to a second location.

Another method of the invention includes the first location being an orchard or a field.

Another method of the invention includes the second location being selected from among a sorting facility, a washing facility, and a packaging facility.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a perspective view of a bin carrier machine.

FIG. 2 is a right side of the bin carrier machine of FIG. 1.

FIG. 3 is a front elevational view of the bin carrier machine of FIG. 1.

FIG. 4 is a rear elevational view of the bin carrier machine of FIG. 1.

FIG. 5 is a front elevational view of another embodiment of a bin carrier machine having two elevated platforms.

FIG. 6 is a top perspective view of a sensor connected to a front portion of a bin carrier machine to detect contact and distance from plants by which the machine is moving.

### DETAILED DESCRIPTION

The invention provides systems and methods for collecting and transporting harvested produce in fields and orchards having substandard-sized row widths. Specifically, the invention relates to a bin carrier machine 10 capable of navigating between rows of plants where the rows include widths less than standard-sized rows. The bin carrier machine is particularly designed to navigate rows of dwarf variety fruit trees such as, for example, dwarf variety apple trees, in orchards.

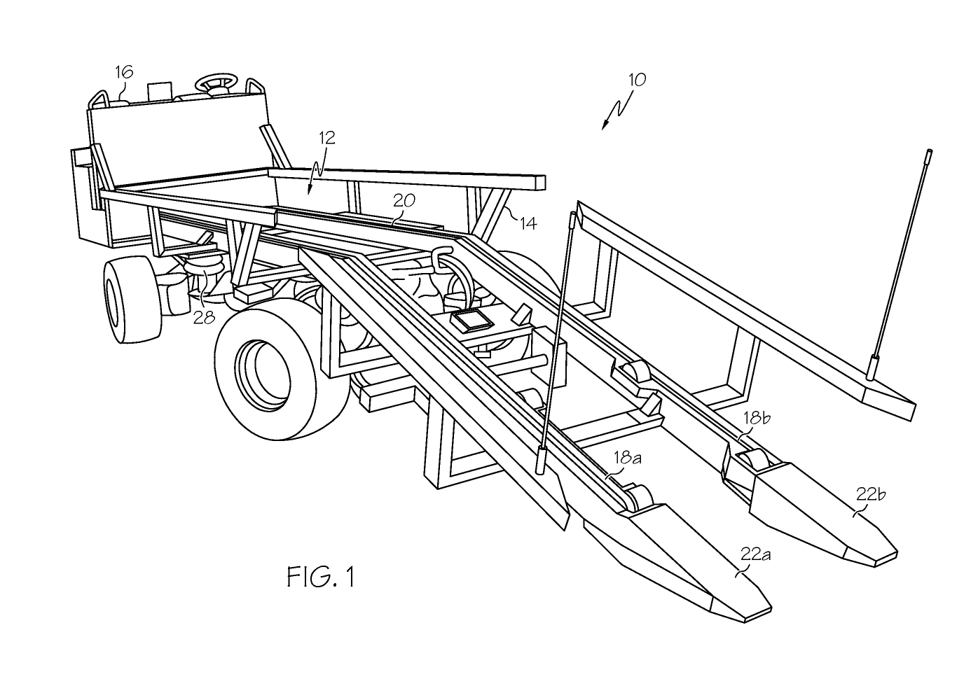

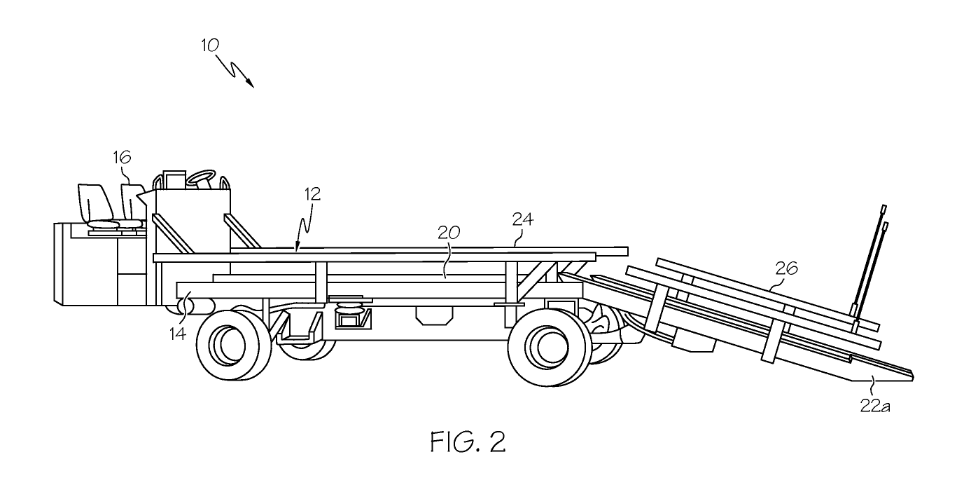

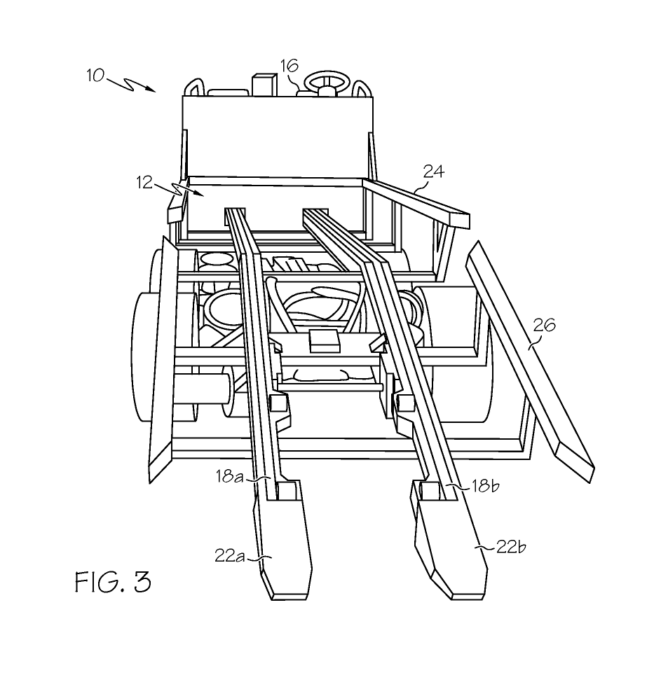

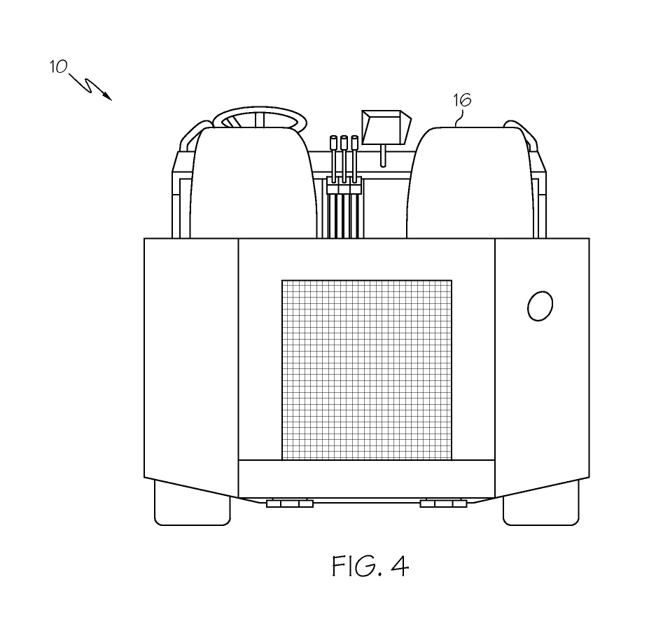

As shown in FIGS. 1, 2, 3, and 4, the bin carrier machine can be a tractor 10 that includes a storage compartment 12 into which a plurality of bins can be loaded. The tractor 10 can further include a body frame 14, at least two axles, a chassis, and a motor. The frame can include the storage compartment 12. The at least two axles can include a front axle and a rear axle. In an exemplary embodiment, the maximum width of the tractor may be about 68.5 inches, which can be measured as tire-to-tire width, to enable the tractor is capable to navigate between closely spaced rows of plants. In other embodiments, the maximum width of the tractor can be about 48, 50, 54, 55, 60, 65, 66, 70, 72, 75, 78, or 84 inches. The maximum width of the tractor can be measured using the two most distant parallel lateral parts of the tractor such as, for example, an outer edge of two wheels installed on opposite ends of an axle. The frame of the tractor can be about 56 inches in width. In other embodiments, the frame of the tractor can be about 36, 40, 48, 50, 54, 55, 60, 66, 70, 75, 78, or 84 inches. In an exemplary embodiment, the tractor frame's width can be less than the tractor's maximum tire-to-tire width, for example, the distance measured from an outside surface of one tire on an axle to an outside surface of another tire on an opposite end of the same axle.

The bin carrier machine can include a plurality of tires such as, for example, 3, 4, 5, 6, 7, 8, or 9 tires. The bin carrier machine 10 can also include an operator compartment 16 and at least two front chain rollers 18a and 18b installed on a floor 20 of the storage compartment 12. In one embodiment, the floor of the storage compartment may comprise a solid horizontally planar surface extending the width and length of the storage compartment. In an exemplary embodiment, the floor of the storage compartment can be two or more support rails disposed longitudinally and collinearly across the length of the storage compartment. The operator compartment can be the same in width as the frame of the bin carrier machine. The front chain rollers may be passive or may be actively controlled by mechanical means to move produces bins to a rear part of the storage compartment. In an exemplary embodiment, the chain rollers are mechanical in nature and may be reversible in direction so that the bin carrier machine can both load and unload bins stored within the storage compartment.

A front portion 24 of the storage compartment 12 can include at least two prongs 22a and 22b that are vertically adjustable and used to lift bins into the storage compartment. Once lifted by the prongs, which may feature hydraulic or mechanical lifting mechanisms, a bin can be moved into a horizontally fixed rear portion 26 of the storage compartment by the chain rollers. The chain rollers can be reversed in direction to move a bin out of the rear portion to the front portion of the storage compartment where the bin can be unloaded from the bin carrier machine.

The bins may be specially designed featuring two or more channels or grooves on a bottom surface of each bin for receiving the prongs of the bin carrier machine. The operator may maneuver the bin carrier machine to align the prongs with the channels of a bin. The prongs may slide into the channels and, as the prongs are lifted vertically, the bin can also be lifted and moved toward the rear portion of the storage compartment by the chain rollers or other mechanical or manual means.

In an exemplary embodiment, the operator compartment can be positioned so as to be aligned collinearly behind the storage compartment. By centrally aligning the operator compartment behind the storage compartment, the maximum width of the bin carrier machine can be reduced further as opposed to other embodiments in which the operator compartment can be positioned offset, and thus protrude, to one side of the storage compartment.

In another embodiment, the operator compartment can be elevated above the storage compartment by a plurality of support elements. This embodiment can be useful for positioning the user or operator of the bin carrier machine above a canopy of the fruit trees so as to avoid contact between the branches of the fruit trees and the operator as the bin carrier machine moves between rows in an orchard.

The bin carrier machine 10 may also include an air bed ride 28 and four-wheel suspension to stabilize the machine and bins contained therein as the machine moves across rough terrain such as a plowed field. In one embodiment, the bin carrier machine can include a hydraulic suspension system to reduce the bouncing and movement of produce carried by the machine. In another embodiment, the bin carrier machine can include an air cushion system to soften the movement of produce during transportation by reducing the impact caused by bouncing of the produce within the bins.

The bin carrier machine can further include a camera to facilitate the loading and unloading of bins into and out of the storage compartment. The camera may be linked to a monitor installed in the operator compartment so that the machine's driver or operator can control the alignment of the machine's storage compartment and front chain rollers with a bin in a field, vineyard, or orchard that is to be loaded.

The bin carrier machine can also include an automatic steering system that enable the machine to move along straight and curved rows of plants in a predetermined course or at a predetermined angle. The automatic steering system can include a global positioning system (GPS) capable of receiving a signal from global positioning satellites in order to calculate the machine's position in a field or orchard.

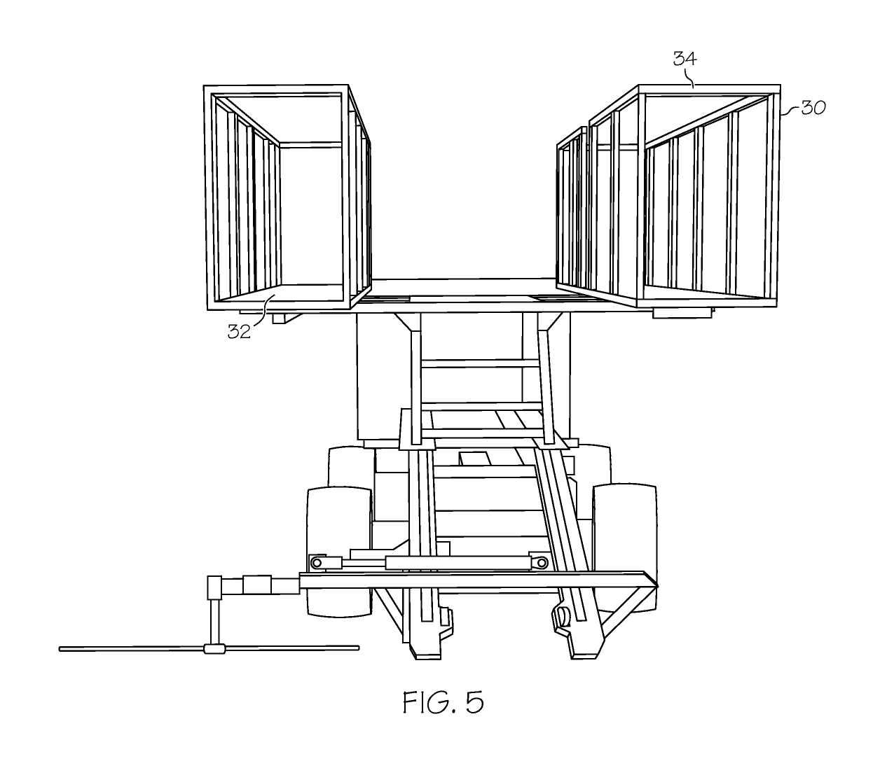

As shown in FIG. 5, the machine can feature at least one elevated platform 30. The platform 30 can be positioned and installed above the machine's storage compartment 12. The platform 30 can include a generally horizontal surface 32 on which an individual can stand to perform any of various functions. For example, the individual could act as a look-out to assist an operator in guiding the machine between rows of plants, around obstacles, and to align the prongs for picking up bins. In another example, the individual may stand on the platform to cut or prune plants, e.g., fruit trees, as the machine moves between rows. In still another example, the individual may stand on the platform to pick produce that is out of reach to pickers standing on the ground. More than one individual may stand on each platform. The machine can include two platforms in some embodiments. The platform may be removable or permanently connected to the machine. The platform may extend most of the length of the machine. In one embodiment, the platform can extend only above the storage compartment. The platform can be fixed in position. In another embodiment, the platform can include components that permit the platform to be raised and lowered in a vertical orientation. The platform can include a ladder connected thereto to permit the individual to climb up and onto the platform. The platform can also include safety rails 34 to prevent the individual from falling off of the platform.

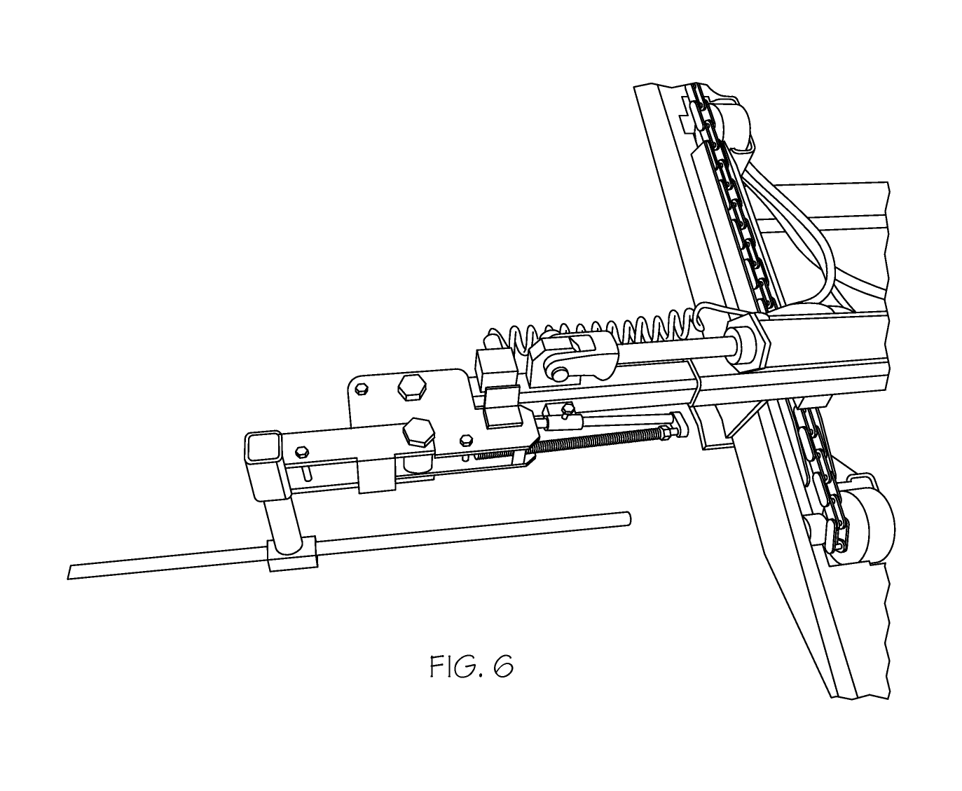

In another embodiment, as shown in FIG. 6, the machine can include a sensor 36 that detects when the machine is a certain distance away from the plants. For example, the sensor can detect when the machine moves too close to the plants to prevent damage to the plants and to the machine. The sensor can be mechanical, hydraulic, or electronic in nature. The sensor can include a movable rod that extends to one side or to both sides of the machine.

In one embodiment, the bin carrier machine can be manufactured in multiple sizes, shapes, or versions of three pieces (the frame, the body, and the motor) that can be interchanged or recombined depending upon the user's need. The body can include the storage compartment and operator compartment. The frame can be an axle frame. For example, the manufacturer may produce several versions of the body frame that can be connected interchangeably to the chassis.

The plants can be fruit trees, vegetables, fruit bushes or low-growing fruit or vegetable plants. In an exemplary embodiment, the plants can be a dwarf variety of fruit trees. For example, the fruit trees can be dwarf variety apples. In another embodiment, the bin carrier machine may be used to collect and transport grapes from a vineyard.

The invention also relates to methods for planting and harvesting crops. In one embodiment, the method can include the step of planting produce crops in a first location in rows spaced about 10 feet apart or less. The first location can be an orchard or a field in which produce plants such as, for example, vegetables or fruit bushes or other low-growing fruit plants are grown. Next, the method can include the step of picking produce and placing the produce into a plurality of bins. The method then can include the step of navigating a bin carrier machine with a maximum width of about 72 inches between the rows. In another step of the method, the plurality of bins can be collected by placing the plurality of bins into a storage area of the bin carrier machine. Finally, the method can include the step of transporting the produce to a second location such as, for example, a sorting facility, a washing facility, and a packaging facility.

The bin carrier machine and method can be used to load and unload about 500-700 bins per day, although this number may be lesser or greater depending upon the number of hours worked, road/terrain conditions, and length of transport from field to loading dock.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A bin carrier machine, comprising a tractor comprising a storage compartment into which a plurality of bins can be loaded, wherein the maximum width of the tractor enables the tractor to navigate between closely spaced rows of plants.

2. The bin carrier machine of claim 1, wherein the storage compartment comprises a front portion that is vertically adjustable and a rear portion.

3. The bin carrier machine of claim 2, wherein the front portion of the storage compartment is vertically adjustable in height from a lowered position to a raised position.

4. The bin carrier machine of claim 2, wherein the front portion of the storage compartment is vertically adjustable via hydraulic means.

5. The bin carrier machine of claim 2, wherein the front portion of the storage compartment comprises at least two prongs.

6. The bin carrier machine of claim 1, wherein the storage compartment comprises at least two front chain rollers installed on a floor of the storage compartment.

7. The bin carrier machine of claim 6, wherein the front chain rollers are mechanically reversible in direction.

8. The bin carrier machine of claim 2, wherein the rear portion of the storage compartment is fixed in a horizontal position.

9. The bin carrier machine of claim 1, wherein the bin carrier machine comprises at least one elevated platform.

10. The bin carrier machine of claim 1, wherein the bin carrier machine comprises at least one sensor.

11. The bin carrier machine of claim 1, further comprising a plurality of tires and an operator compartment.

12. The bin carrier machine of claim 11, wherein the operator compartment is aligned collinearly behind the storage compartment.

13. The bin carrier machine of claim 11, wherein the operator compartment is elevated above the storage compartment.

14. The bin carrier machine of claim 11, wherein the operator compartment is offset to one side of the storage compartment.

15. The bin carrier machine of claim 1, wherein the bin carrier machine further comprises a camera to facilitate loading of bins.

16. The bin carrier machine of claim 1, wherein the bin carrier machine further comprises a frame comprising an air cushion.

17. The bin carrier machine of claim 1, wherein the bin carrier machine further comprises a hydraulic suspension system.

18. A method of planting and harvesting crops comprising the steps of:
(a) planting produce crops in a first location in rows spaced about 10 feet apart or less;
(b) picking produce and placing the produce into a plurality of bins;
(c) navigating a bin carrier machine with a maximum width of about 72 inches between the rows;
(d) collecting the plurality of bins by placing the plurality of bins into a storage area of the bin carrier machine; and
(e) transporting the produce to a second location.

19. The method of claim 18, wherein the first location is an orchard or a field.

20. The method of claim 19, wherein the second location is selected from the group consisting of: a sorting facility, a washing facility, and a packaging facility.
